(19) United States
(12) Patent Application Publication
(10) Pub. No.: US 2020/0190268 A1
(43) Pub. Date: Jun. 18, 2020

(54) SYSTEMS, DEVICES, AND METHODS FOR BULK PROCESSING OF HIGHLY-LOADED NANOCOMPOSITES

(71) Applicant: Massachusetts Institute of Technology, Cambridge, MA (US)

(72) Inventors: Abhinav Rao, San Jose, CA (US); Anastasios John Hart, Waban, MA (US)

(21) Appl. No.: 16/712,516

(22) Filed: Dec. 12, 2019

Related U.S. Application Data
(60) Provisional application No. 62/780,187, filed on Dec. 14, 2018.

(51) Int. Cl. C08J 3/205; B29C 64/291; B29C 64/106; B29C 64/321; C08J 3/28

(52) U.S. Cl. CPC C08J 3/205; B29C 64/291; B82Y 30/00; B29C 64/321; C08J 3/28; B29C 64/106

(57) ABSTRACT

Methods, systems, and devices for synthesis, mechanics, and direct-write additive manufacturing of cellulose nanocrystal (CNC) composites that exhibit characteristics of high-performance structural materials are provided. The methods, systems, and devices allow for formulation, processing, and bulk fabrication of highly-filled nanocomposites having high hardness and toughness. In some embodiments, a precursor that includes a nanomaterial and one or more monomers is formulated and passed through an extruder to form a physical gel. The physical gel can undergo a dual cure process that includes an initial UV cure and a subsequent thermal cure to crosslink the polymer with the CNC to form the highly-filled nanocomposite. The CNC composite can then be used in the manufacturing process. In some embodiments, the interfacial mechanics and fracture characteristics of the composite can be tuned to improve the mechanical properties of the composite.

### CROSS REFERENCE TO RELATED APPLICATION

The present application claims priority to and the benefit of U.S. Provisional Application No. 62/780,187, filed on Dec. 14, 2018, and titled “Systems, Devices, and Methods for Bulk Processing of Highly-Loaded Nanocomposites,” the contents of which is incorporated herein by reference in its entirety.

### FIELD

The present disclosure relates to systems, devices, and methods for processing nanocomposites, and more particularly relates to formulation, processing, and post-processing of highly-filled nanocomposites that allows for fabrication of macroscale components having desirable strength and fracture characteristics, including by performing additive manufacturing.

### BACKGROUND

Various industries are on a constant search for alternative structures that can be used in the manufacturing process in lieu of, or in addition to, expensive materials such as steel, aluminum, titanium, and other metals that possess desirable properties for commercial use while often having adverse environmental effects. Any such structures are ideally durable, easily accessible in large quantities, and possess low manufacturing costs. For example, cellulose nanocrystals (CNCs) are a naturally derived, widely available, sustainable, and biodegradable nanostructure with exceptional mechanical properties. In some embodiments, individual CNCs can have a Young's modulus of about 150 GPa, which allows materials made from CNCs to have high stiffness and a strong resistance to deformation under elastic loads. CNCs can also have small diameters, e.g., 10 nm, and lengths, e.g., 100 nm, which allows incorporation of large numbers of CNCs into materials to produce nanocomposites. Such a combination of stiffness and size is, at best, difficult to attain by conventional micron-scale inorganic fillers and metal powders, making CNCs an attractive alternative to existing materials that are used to manufacture structures that require exceptional mechanical properties, such as high stiffness, high toughness, and durability.

Naturally occurring composites having exceptional mechanical properties, such as enamel and nacre, are characterized by a high volume fraction of generally hard nano- or microscale, inorganic mineral inclusions, and a fraction of softer interfacial material. For example, enamel has a mineral fraction of approximately 96%. Additionally, existing natural composites (e.g., nacre) possess a multi-scale structural organization that enables specific load transfer and toughening mechanisms. For example, nacre is composed of layers of aragonite that are separated by sheets of organic matrix composed of elastic biopolymers, which makes the material strong and resilient, as evidenced by a high Young's Modulus of approximately 70 GPa. In light of these parameters, in order for any synthetic nanocomposites to mimic the characteristics of a natural composite, high loading of nanoparticles, and a mechanism for interaction between the nanoparticles and the interface, are preferable characteristics that would allow the synthetic to qualify as a viable substitute.

However, among other issues, flocculation, phase separation, and kinetic arrest of nanoparticle suspensions limits the practical processing of most bulk nanocomposites to have a low volume fraction of nanoparticles. Existing methods for nanocomposite processing also feature melt processing and surface treatment to blend nanoparticles and polymers without taking account of their relative volume fractions, which may lead to substances having low volume fractions of nanoparticles that are not sufficiently tough or durable.

Additive manufacturing, also generally referred to as three-dimensional (“3D”) printing, is growing in popularity as a way to prototype and manufacture physical objects. There are multiple known techniques for printing polymer-based materials three-dimensionally, such as stereolithography, binder jetting, filament extrusion, and direct ink writing.

Direct ink writing is a versatile additive manufacturing technique in a computer numerically controlled fluid dispensing system that is capable of depositing two-dimensional patterns in multiple layers in space, thereby producing a 3D part. This technique can readily be adapted to a variety of materials including shear-thinning colloids, gels, and polymer melts. In additive manufacturing, the solidification of inks takes place either by solvent evaporation, thermosetting, or phase-change. Further, direct ink writing is a powerful method for precisely controlling the local microstructure of heterogeneous materials by tuning the flow properties and in the case of multi-material deposition, the local composition. This makes it a highly suitable method for manufacturing bulk nanocomposites.

Existing methods for direct additive manufacturing of composites are typically limited to low volume fractions of solid filler. The processing of highly-filled nanocomposites presents several challenges, which include phase separation during formulation, stability of the precursors, and the limitations on viscosity for flow through extruders or into molds. The inclusion of a solvent typically results in a large volumetric shrinkage and can result in phase separation due to internal flows during solvent evaporation. Composites with high loading fractions of nanoparticles, as well as a small polymer fraction, are generally limited to processes like solvent casting, which typically cannot be used for 3D structures, and involve a large volume change during solvent evaporation that makes shape forming impractical. As a result, these composites are typically restricted to thin films.

Accordingly, there is a need for improvements in the formulation, fabrication, and processing of highly-filled nanocomposites that can be used to additively manufacture and shape form materials having desirable interfacial mechanics and fracture characteristics.

### SUMMARY

The present disclosure relates to systems, devices, and methods for processing nanocomposites to produce highly-filled nanocomposites having high loading fractions that can be used for shape forming and additive manufacturing sustainable, high-performance structural materials with exceptional mechanical and chemical properties. The formulations disclosed herein, by themselves and in any combination, can be integrated into the instantly disclosed additive manufacturing process, or, in view of the present disclosures, can be used in conjunction with a number of processes known to a person skilled in the art such as extrusion, stereolithography (SLA), direct ink writing, casting (e.g., blade-casting), embossing, and imprinting. The present disclosure highlights some formulations and manufacturing processes with more particularity than others, although such highlighting by no means indicates the inventive nature of one advance or aspect in comparison to another. A person skilled in the art, in view of the present disclosure, will be able to determine the features, and combinations of features, that represent inventive subject matter.

In one exemplary embodiment of a method for preparing a precursor, the method includes adding a compound to a solvent to form a solution, and mixing the solution until the compound is dispersed throughout the solution. The method also includes adding one or more curing agents to the solution. The one or more curing agents are configured to permit crosslinking between a nanomaterial and the compound. Further, the method includes adding the nanomaterial to the solution such that a physical gel is formed, and dispersing the nanomaterial such that the physical gel is homogeneous.

In some embodiments, the method can further include bonding the nanomaterial to the compound to create a chemical gel. The nanomaterial can include at least one of a nanocrystal, a nanotube, or a nanoplatelet. Some non-limiting examples of nanomaterials can include a cellulose nanocrystal, carbon nanotubes, boron nitride nanotubes, metal nanoparticles, clay platelets, graphene, and graphene oxide. In some embodiments, the nanomaterial can be a cellulose nanocrystal(s) (CNC). The bonding can be initiated by applying an optical energy and/or a thermal energy. In some embodiments, the method can include adding a second compound having different chain properties to the precursor to change the stiffness of the nanocomposite.

The method can further include shape forming the chemical gel into a nanocomposite of a desired shape. Shape forming can include one or more of additive manufacturing, extrusion, stereolithography, casting, embossing, and imprinting. Other shape forming methods are also possible. The loading fraction in the nanocomposite can be approximately in a range of about 50 percent to about 90 percent, and/or can have a nanomaterial to compound ratio approximately in a range from about 50:50 to about 90:10.

A number of additional steps for preparing the precursor are provided for herein or are otherwise derivable from the present disclosures. For example, the method can further include extracting the solvent from the chemical gel. Other examples can include performing a first thermal cure over a first period of time at one of a first temperature and a first temperature range, and performing a second thermal cure over a second period of time at one of a second temperature and a second temperature range, where the first temperature is less than the second temperature and temperatures used in the first temperature range are less than temperatures used in the second temperature range. The cure can be performed in a variety of ways. For example, one or more of the cures can include operating a UV lamp to perform the cure. The first temperature range can be approximately in the range of about 50 degrees Celsius to about 100 degrees Celsius, and the second temperature range can be approximately in the range of about 120 degrees Celsius to about 180 degrees Celsius. In some embodiments the first thermal cure and the second thermal cure can be performed under elevated atmospheric pressure. For example, the second thermal cure can be performed under a pressure of approximately 75 psi or greater. In some embodiments, an amount of nanomaterial that is added to the solution is an amount such that the nanoparticle to solvent ratio is at or above approximately 5 percent by mass above a gelation threshold for suspension.

The method can further include adding one or more of a photoacid generator and a thermal curing agent to the solution. In some embodiments, the method can further include exposing the combination of the nanomaterial, the solution, and the one or more curing agents to one or more wavelengths of light, and/or heating the combination of the nanomaterial, the solution, and the one or more curing agents to a temperature that exceeds approximately room temperature, to cause crosslinking between the nanomaterial and the compound to occur.

A variety of substances can be used in preparing the precursor. For example, the compound can include one or more of an epoxide monomer and a polymer. The epoxide monomer can include one or more of bisphenol-A-diglycidyl ether and polyethylene glycol diglycidyl ether. The solvent can be a polar solvent. For example, in some embodiments, the polar solvent can include dimethylformamide.

In one exemplary embodiment of a method for printing a three-dimensional part, the method includes preparing a precursor, with the precursor including a compound, nanostructures, a solvent, and one or more curing agents. The method further includes loading the precursor into a printer, depositing the precursor from the printer onto at least one of a surface or one or more layers of previously deposited precursor, and exposing the precursor to at least one of optical energy or thermal energy such that the nanostructures become partially bonded to the compound via activation of at least one curing agent of the one or more curing agents. Still further, the method includes extracting the solvent from the deposited materials, repeating the depositing, exposing, and extracting actions to form a three-dimensional part, and exposing the three-dimensional part to at least one of optical energy or thermal energy to further increase the number of crosslinks between the nanostructures and compound via activation of at least one curing agent of the one or more curing agents.

Depositing the precursor can further include one or more of extrusion, blade-casting, direct ink writing, embossing, and imprinting. The precursor can be deposited in two-dimensional patterns in multiple layers. In some embodiments, the actions of depositing the precursor and curing the deposited precursor occur approximately simultaneously. The action of depositing the precursor can be performed by a computer numerically controlled fluid dispensing system. In some embodiments, the surface on which the precursor is deposited can be a three-axis stage. The method can further include extruding the precursor at a preset pressure that is higher than a yield stress of the precursor.

Additional steps can be performed to change or alter printing of the three-dimensional part. For example, varying a ratio of the nanoparticle to compound in the precursor can change a composition of the precursor. A ratio of the nanoparticle to the compound in the nanocomposite can be approximately in the range of about 50 percent to about 90 percent. Another example can include varying a speed of deposition of the precursor and a speed of curing of the precursor. The printer can include additional means for printing the three-dimensional part. For example, the printer can include an irradiation source for curing the precursor. In some embodiments, optical energy can be applied by one or more an LED, a projector, and a laser.

### BRIEF DESCRIPTION OF DRAWINGS

This disclosure will be more fully understood from the following detailed description taken in conjunction with the accompanying drawings, in which:

FIG. 1 is a perspective view of one exemplary embodiment of a 3D-printing device;

FIG. 2A is a schematic illustration of one exemplary embodiment of a print test pattern extruded for use in conjunction with 3D-printing and curing methods provided for herein;

FIG. 2B is a schematic illustration of another exemplary embodiment of a print test pattern extruded for use in conjunction with an additional curing method provided for herein;

FIG. 3 is a schematic illustration of a dual cure process that is applied to a gel extruded by the printing device of FIG. 1;

FIG. 4 is a graph of yield stress behavior of a precursor gel having an 80% loading fraction;

FIG. 5A is polarized image of a cellulose nanocrystals (CNC)-epoxide composite film produced by the process of FIG. 3;

FIG. 5B is an AFM topography image of an indent in a CNC-composite grain of the film in FIG. 5A;

FIG. 5C is an AFM topography image of a fracture toughening mechanism of the CNC-composite grain of the film in FIG. 5A;

FIG. 5D is a graph of a composite film and a pure CNC film illustrating a comparison of the hardness of the two films;

FIG. 6A is a schematic illustration of a molecular structure of an interface between CNC and a stiff polymer;

FIG. 6B is an AFM topography image of the interface between the CNC and the stiff polymer of FIG. 6A;

FIG. 6C is a modulus map from the AFM topography image of FIG. 6B;

FIG. 6D is a schematic illustration of a molecular structure of an interface between CNC and a flexible polymer;

FIG. 6E is an AFM topography image of the interface between the CNC and the flexible polymer of FIG. 6D; and

FIG. 6F is a modulus map from the AFM topography image of FIG. 6E.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, to the extent features, sides, or steps are described as being “first” or “second,” such numerical ordering is generally arbitrary, and thus such numbering can be interchangeable.

It will be appreciated that a number of different terms can be used interchangeably while still being understood by the skilled person. By way of non-limiting example, the terms “highly-filled nanocomposites” and “highly-loaded nanocomposites” are generally used interchangeably to describe a cellulose nanocrystals (CNC) composites produced by the instantly disclosed processes having a large nanoparticle to polymer ratio. Further, the terms “loading fraction,” “mass fraction,” and “volume fraction” are generally used interchangeably to describe a content or the nanoparticle to polymer ratio of one of the substance provided herein, as are the terms “composites” and “nanocomposites,” which are generally used to describe the structures that are formed from the nanocomposite gels and used in the direct-write additive manufacturing processes provided for herein, or otherwise derivable from the present disclosures. Additionally, to the extent the terms “depositing” and “extruding” are described in the present disclosure, a person skilled in the art will recognize that “extruding” is one form of depositing a filament, and that it typically involves ejecting a material from a nozzle, while “depositing” more generally describes a variety of ways by which a material can be printed. While the present disclosure primarily describes depositing materials for printing via one or more nozzles, and thus primarily describes extruding, a person skilled in the art will recognize that the same techniques can be applied to other techniques for depositing materials during 3D printing, including powder bed sintering and stereolithographic methods. Accordingly, to the extent the term nozzle is used herein, a filament guide or other object used for depositing material can be used interchangeably or in conjunction with a nozzle.

The present disclosure relates to systems, devices, and methods for formulation, processing, and post-processing of highly-filled nanocomposites with nanoscale features. Highly-filled nanocomposites refer to nanocomposites having large nanoparticle to polymer ratios (e.g., in the range of about 50 percent to about 90 percent) that exhibit toughness and fracture characteristics that are similar to natural composites such as enamel and nacre, and are desirable in engineering materials, especially as compared to common nanocomposites. These highly-filled nanocomposites can be manufactured using compatible nanostructures, e.g., cellulose nanocomposites or CNCs, added to one or more of a monomer(s), a thermal and UV crosslinker(s), nanoparticles, and a solvent(s) to form a nanocomposite physical gel. The physical gel can be loaded into an extruder that is attached to a numerically controlled three-axis stage, and deposited in layer-by-layer 2D patterns onto a build platform. The physical gel can undergo a single or dual cure process to crosslink the physical gel to form a chemical gel to enable direct write additive manufacturing of a 3D structure. For example, the single cure process can utilize a single energy source for crosslinking (e.g., UV energy or thermal energy), but may be performed in several stages with different intensities or temperatures applied over different periods of time. By way of further example, the dual cure process can include an initial, UV cure, which can lock the different microstructure in the gel in place for hardening, and a subsequent, thermal cure, which can help complete the crosslinking of the nanocomposite and the polymer to form a highly-filled nanocomposite. One having ordinary skill in the art will appreciate that the integration of the nanocomposite formulation and processing with additive manufacturing can enable local control of microstructure over a bulk part having desirable interfacial mechanics and fracture characteristics.

Printing Systems and Devices

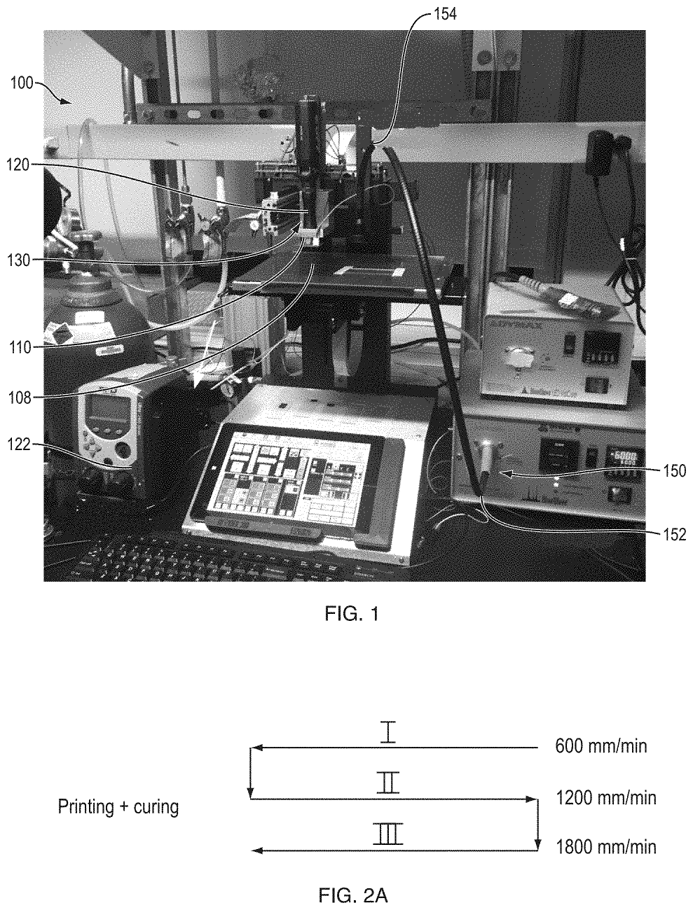

FIG. 1 provides one exemplary embodiment of a three-dimensional printing device or printer 100 set-up for additive manufacturing. The printer 100 can dispense fluid in a controlled manner to create two-dimensional patterns in multiple layers, thereby producing a 3D part. The illustrated embodiment includes nozzles 110 for deposition of materials used in the printing process, but a person skilled in the art will recognize that various other means of depositing materials onto a printing surface can be used. In some embodiments, the printer 100 can include a syringe 120 that is connected to a pressure controller 122 to regulate the pressure at which extruded substances are deposited. The materials that can be deposited by the syringe 120 can include liquid inks that can be used to dissolve cellulose, cellulose acetate, as well as other materials provided for herein, or otherwise known to those skilled in the art in view of the present disclosures. These materials can then be dissolved in a solvent that bonds as the solvent evaporates, thereby allowing rapid part production. The solvent used can be a polar solvent, such as dimethylformamide, as polar solvents can serve as strong dispersants of cellulose nanocomposites to form well-dispersed suspensions of nanoparticles, but a person skilled in the art will recognize that other solvents having rapid evaporation capabilities can also be used. Additional information about materials that can be used in conjunction with the printing devices, systems, and methods provided for in the present disclosure, including various deposition materials, solvents, adhesives, and materials to wash away materials that provided adhesive forces following deposition, are provided below, as well as throughout the present disclosure and those disclosures incorporated herewith.

In a bench model of the printer 100, the printer can be a modified Hyrel Engine SR Printer, manufactured by Hyrel 3D of Norcross, Ga., where such modifications include replacing the standard printhead with a pneumatic extruder. The pneumatic extruder becomes a printhead 130 in this modified version of the 3D printer. In some embodiments, the syringe 120 can also be modified from a volume-driven syringe to a pressure-driven syringe that is controlled by the pressure controller 122, as discussed above. It will be appreciated that many different 3D printers and syringes, or similarly capable components, can be used in conjunction with the present disclosures. Components of a printer 100 can include, but are not limited to, one or more drivers to advance one or more printheads 130 on which one or more nozzles 110 can be disposed, as well as a controller to control and/or operate, among other things, a print path along which the printhead(s) are moved and/or components of the printer that help control the rate at which a solvent released by the syringe 120 evaporates or extrudate is ejected from the nozzles 110. Other existing printers can also be modified and/or used in conjunction with the present disclosures and/or printers can be assembled from scratch to perform the methods and/or in conjunction with the systems provided for herein.

Various chambers for housing materials to be printed can also be part of the printer. The printer 100 is able to move across an x-y plane to deposit material onto a surface. The movement of the printer 100 in the x-y plane is a capability of 3D printers, and thus a description of how it is able to move in the x-y plane is unnecessary since it is understood by those skilled in the art. Many different ways by which movement in the x-y plane can be achieved are contemplated by the present disclosure, and typically such movements can be utilized in conjunction with the present teachings.

The surface upon which the deposited materials can be printed can be any surface. In the illustrated embodiment, a surface or build platform 108 is substantially flat, and thus has its own x-y plane. In some embodiments, the extruder 130 is attached to a numerically controlled three-axis stage which can move in all six degrees of freedom to facilitate deposition of the extrudate onto the surface 108 to print the 3D structure. As described in greater detail below, for instance when describing extruding the gel onto the surface 108, a z-height of the printhead 130 can also be adjusted, thus allowing the printer 100 to print in three dimensions. Alternatively, or additionally, the build platform 108 can be moved along the z-axis to provide for printing in three dimensions. In some instances, the build platform 108 can have six degrees of freedom, permitting additional ways by which the location onto which the materials is deposited can be manipulated. A person skilled in the art understands how a 3D printer is able to move in a third plane, and across six degrees of freedom, to adjust a location of one or more nozzles 110 of the printhead 130, and thus further explanation is not provided herein.

Moreover, in view of the present disclosures, the printer 100 can print onto a more contoured surface at least because the disclosures provided for herein allow the printed materials to conform to the surfaces onto which they are printed. It will be appreciated that because 3D printing necessarily results in an object having three dimensions, and because the present disclosures relate to additive manufacturing, printing also occurs onto material that has already been deposited, such as filament, fluids, gels, inks, or other materials previously deposited by the printer 100 and/or other material otherwise disposed on the surface and/or the previously deposited material.

The printer 100 can include one or more light sources or irradiating sources 150 attached thereto. The irradiating sources 150 can be used as a part of the dual cure process to prepare the physical gel for additive manufacturing by crosslinking the CNCs and polymer to lock different microstructures in the gel for hardening on the surface. When crosslinking occurs, bonds between the CNCs and polymer(s) (or other compound used in conjunction with, or in lieu of, one or more polymers) can be formed. For example, the irradiating source can include one or more LEDs that are configured to photocure the physical gel 200 on the surface. Photocuring the gel can enhance the mechanical and microstructural integrity of the gel. As shown, the printer can include a light guide mount 152 for attaching the irradiating source 150 to the extruder 130, though it will be appreciated that the irradiating source can also be integrated into the extruder, extend from the extruder, or otherwise associated with the extruder to allow the light source to interact with the physical gel 200. In some embodiments, the LEDs can be positioned around the nozzle 110 to allow the printer 100 to deposit and cure the physical gel approximately simultaneously, that is, basically at the same time for the purposes of printing.

In some embodiments, the printer 100 can further include an additional light source to aid in cross-linking the physical gel to form the chemical gel. For example, the printer 100 can include a UV lamp 154 that can perform an initial cure on the physical gel 200 to solidify the gel into the desired structure. The UV lamp can partially crosslink the physical gel 200 that passed through the extruder 130 to form a chemical gel 210, which can be used in the three-dimensional printing process, as described below. It will be appreciated that the partial crosslinking of the physical gel can create chemical bonds that are present in the chemical gel. In some embodiments, the UV lamp 154 can be used to cure materials to form colloids, suspensions, and so forth, and its function is not limited solely to curing the physical gel 200 for making the CNC composite.

Non-Limiting Examples of Materials for Use with the Printing Systems, Devices, and Methods Provided

The present disclosure provides for a variety of materials that can be used in conjunction with the present additive manufacturing disclosures. Some non-limiting examples of substances used in the additive manufacturing process can include shear thinning colloids, gels, and/or polymers, such as Bisphenol-A-diglycidyl ether, polyethylene glycol diglycidyl ether, trimethylolpropane triacrylate, and other monomers, polymers, and oligomers containing methacrylate or epoxide functional groups. In some embodiments, the surface onto which the material is deposited is an adhesive surface (e.g., a surface that is covered in an adhesive material). Further, as the present disclosures relate to direct ink writing, which is a hybrid additive manufacturing process in which a numerically computer controlled fluid dispensing system that deposits two-dimensional patterns in multiple layers to produce a 3D part.

Materials that can be used in conjunction with the devices and systems provided for in the present disclosure, like the printer 100, are vast, and can depend on a variety of factors, including but not limited to the desired properties of the object being printed (e.g., flexible, tough, and/or rigid), the desired use of the object being printed (e.g., a frame for a bicycle or a drone propeller), the properties of the printer being used, and/or the preferences of the user. The present disclosures allow the materials being used to form a composite that can be integrated into variety of manufactured items as a support or a substitute for metal.

In some exemplary embodiments, pure cellulose and cellulose acetate can be used for structural materials and 3D printing. The cellulose molecule can be a linear polymer with a repeating unit that includes two anhydroglucose rings, (C6H10O5)n where n is approximately in the range of about 10,000 to about 15,000, and that can be linked by covalent bonds. Cellulose can a preferred material because it is the primary reinforcement phase of many biological organisms, including trees, plants, algae, some sea creatures, and bacteria, and is also the most abundant organic polymer on Earth.

In some embodiments, cellulose can be used to create biocompatible or biodegradable composites when crosslinked with a suitable choice of polymer, as discussed in the methods presented below. One having ordinary skill in the art will appreciate, however, that in some embodiments, cellulose nanocrystals (CNCs) can be used in lieu of pure cellulose. CNCs differ from cellulose in that CNCs are a crystalline form of cellulose that are naturally derived, widely available, and biodegradable nanostructure with exceptional mechanical properties at the nanoscale. For example, CNCs are estimated to have a Young's Modulus of up to about 150 GPa, which, when combined with diameters and lengths on the order of about 10 nanometers and about 100 nanometers, respectively, can allow production of high performance nanocomposites with nanoscale features such as high stiffness and a strong resistance to deformation under elastic loads. Such materials can thus be used to achieve mechanical properties at the scales required of engineering materials, scales that are inaccessible by conventional micron-scale fillers and metal powders.

Use of CNCs in the 3D printing process enables the 3D printing of exceptionally strong but flexible materials, sometimes referred to as tough materials, that also have higher mass and/or volume fractions of nano and/or microscale material to interfacial material than cellulose to allow the resulting CNC composite to exhibit superior mechanical characteristics as compared to pure cellulose. For example, nanoscale or microscale materials, such as CNCs, include more mineral inclusions and are generally harder than interfacial material, e.g., polymers, which tends to be softer. These properties of CNCs can allow CNCs to mimic materials having durable mechanical properties such as enamel and nacre, which have structural organizations that allow for specific load transfer and toughening mechanisms. It will be appreciated that an example of such structural organizations can be a high loading of nanoparticles, or loading fractions, which is a mechanism for interaction between the nanoparticles and the interfacial material.

As discussed above, conventional nanocomposites have a low volume fraction of nanoparticles due to kinetic arrest of nanoparticle suspensions. Highly-loaded nanocomposites and other compatible nanostructures, on the other hand, when mixed with solvent, favor gel formation, which is a general characteristic of well-dispersed suspensions of nanoparticles. For example, CNCs can be well-dispersed with polar solvents, e.g., dimethylformamide, to form a colloidal gel that can be used as a precursor for additive manufacturing. In order to formulate these highly-loaded nanocomposites that achieve exceptional mechanical properties, the composites can be synthesized having larger nanoparticle-to-polymer ratios. Nanocomposites having higher loading fractions, for instance at or above approximately 50 percent, or at or above approximately 70 percent, can be considered highly-loaded nanocomposites. It will be appreciated that higher percentages of loading fractions, e.g., up to and including approximately 90 percent, can increase the toughness, strength, and fracture characteristics of the CNC composite due to the prevalence of CNCs throughout the composite.

One having ordinary skill in the art will appreciate that while the highly-loaded nanocomposites being fabricated by the disclosures in this application are discussed with respect to CNCs, other nanoparticles may be used to form nanoparticles at the same and/or different concentrations for processing by additive manufacturing and/or shape molding. Some non-limiting examples of compatible nanostructures can include carbon nanotubes, boron nitride nanotubes, metal nanoparticles, clay platelets, graphene, and graphene oxide. One having ordinary skill in the art will appreciate that while use of these other compatible nanostructures can cause minor alterations to the formulation of the resulting nanocomposites, e.g., lower mass and/or volume fractions, the route towards fabrication of these bulk nanocomposites with nanoscale features would be largely similar and/or identical. In some embodiments, and where noted herein, certain steps in the sequence of the process of fabrication of the nanocomposites can be altered or omitted when an alternate compatible nanostructure is used for formulation of the nanocomposite. The use of alternative highly-loaded nanocomposites beyond CNCs is contemplated by, and achievable in view of, the present disclosures.

Printing Processes

In an exemplary embodiment of the printing processes of the present disclosures, a cellulose nanocomposite, such as CNC nanocrystals, can be dissolved in a solvent, e.g., dimethylformamide, to form a colloidal gel, which is a general characteristic of well-dispersed suspensions of nanoparticles. The gel can be loaded into the extruder 130 of the printer 100 and ejected through the nozzle 110 to deposit the extruded or physical gel 200 onto the surface 108 in a series of layers for additive manufacturing. One having ordinary skill in the art will appreciate that the extruder 130 can be pressurized such that the physical gel 200 is ejected onto the surface 108 at varying pressures that are preset by a user. Alternatively, or additionally, a user, or the system itself, can make adjustments during the course of the printing process, thus altering the presets if desired. Changing the pressure within the printer can regulate properties and/or characteristics of the gel, such as adhesiveness, toughness, and strength, among others. The physical gel 200 can be extruded at constant pressure. It will be appreciated that maintaining the extruder pressure at a desirable value at or near the yield stress of the gel can ensure steady extrusion that is synchronized with the horizontal speed of the print head as the gel is deposited.

The physical gel 200 can be deposited in layer-by-layer 2D patterns onto a build platform to form a 3D object. One having ordinary skill in the art will appreciate that a gel guide can be used interchangeably or in conjunction with the nozzle, and that the printer 100 can include multiple nozzles that are configured to deposit the physical gel 200 onto a surface. In the illustrated embodiment of the printer of FIG. 1, the nozzles 110 can have diameters of approximately 200 μm at their distal tips, though it will be appreciated by one skilled in the art that the diameter of the nozzles can vary. Commercially available nozzles in standard sizes can extrude gel in a bead of different diameters, such as approximately in the range of about 0.5 millimeters to about 10 millimeters, and so forth. The solution can be highly shear thinning, and the rapid evaporation of the solvent can further increase the viscosity of the viscous fluid after ejection. This, in turn, can allow for excellent dimensional control of printed parts.

As described above with respect to the light sources or irradiating sources 150, material deposited can be cured. In the present disclosure, a dual cure process is disclosed, which allows for the printed material to be hardened and cross-linked in a desirable manner.

The systems, devices, and methods disclosed herein can thus allow for local control over a bulk part when manufacturing bulk nanocomposites. The process can be tailored and such that interfacial mechanics and fracture characteristics of the nanocomposite can be engineered and/or tuned according to desired specifications. For example, stiffness of the polymer phase can be tuned for different nanoscale load transfer and failure mechanisms, while affording a wide range of bulk mechanical properties. These instantly disclosed fabrication methods can allow a user such granular control of the processes as selecting a location at which the physical gel is deposited, the extent to which each layer of gel is cured, the consistency of the nanostructures used to form the gel precursor, the shape of the manufactured nanocomposite, and so forth. In some embodiments, parameters such as printhead z-height, solvent concentration, and viscous fluid extrusion rate can be changed to influence deposition and printing. In some embodiments, the printhead can be relatively close to the surface, which can cause the viscous fluid to be adhesive when it reaches the surface and adhere to the underlying layer.

The process outlined herein is very economical because it is rapid and carried out under ambient conditions with a simple air compressor required for extrusion. Moreover, polymers such as cellulose and CNCs are highly abundant while the evaporated acetone is both inexpensive and can be recycled. Additionally, each item is produced as a single part, largely removing the need for assembly and therefore enabling full automation of the production process. Also, it will be appreciated by one skilled in the art that the methods disclosed herein provide for massive parallelization of textile manufacture through the use of multiple printheads.

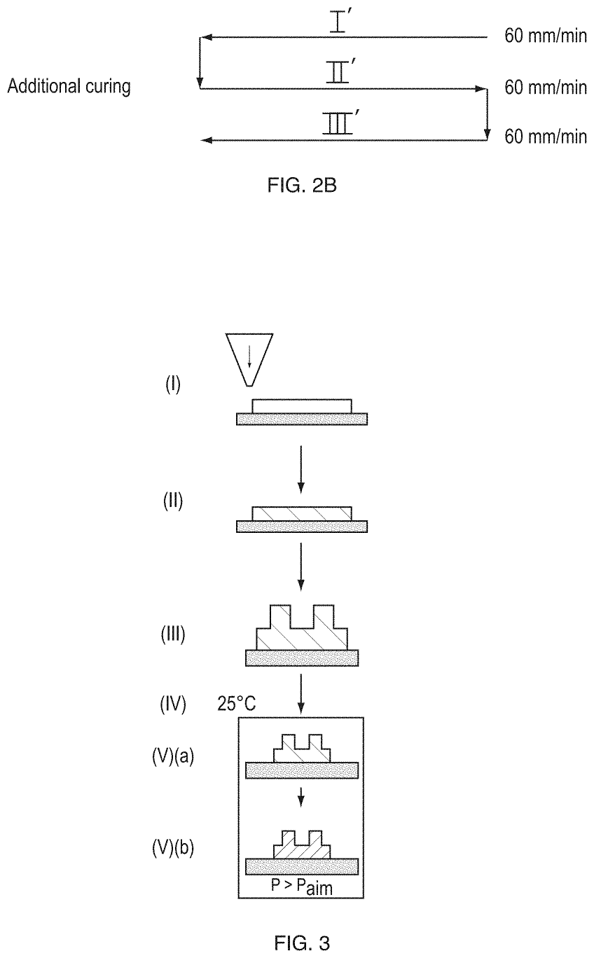

FIGS. 2A-2B illustrate sample test patterns printed by the direct-write additive manufacturing methods described herein. The physical gel 200 that is extruded from the printer 100, as described herein, can be a material that is actively shaped by the nozzle into a ejected gel that can be added layer by layer to form objects (e.g., a colloid that is extruded through the nozzle).

As shown in FIG. 2A, the printer 100 can be used to control the direction and speed at which the physical gel 200 is deposited onto the surface 108. As discussed above, in some embodiments, the printer 100 can perform the initial cure, e.g., the UV cure, during deposition of filament. The degree to which the physical gel 200 is cured, and the direction in which the printhead 130 travels during deposition, can be regulated by the user. For example, the speed and location of the printing and the curing can be accelerated based on a variety of factors. In some embodiments, the speed of the printing and initial cure can be tuned to match a pressure placed on the extruder 130, though, in some embodiments, the speed can be changed based on at least one of the rheology of the gel, the desired production rate of the part, and/or the extrusion pressure set for the nozzle, among other parameters known to those skilled in the art in view of the present disclosures, to ensure a continuous flow of physical gel 200 through the extruder 130. As shown at (I), the printing and initial curing step can begin at a first speed, e.g., approximately 600 millimeters per minute. Once the printer 100 senses that the pressure has increased, the printing and curing can accelerate, e.g., to approximately 1200 millimeters per minute, as shown in (II). One having ordinary skill in the art will appreciate that the values of approximately 600 millimeters per minute and approximately 1200 millimeters per min are merely exemplary and the printing and curing can be performed at speeds that are slower and/or faster than these values. The amount of acceleration during the process, which can also be zero or negative, can depend on many factors, including but not limited to the flow parameters of the physical gel, the desired printing outcome, and other parameters that impact stretching of a filament. In some exemplary embodiments, the acceleration that occurs as the nozzle(s) moves from the second to the third location can be greater than the acceleration that occurs as the nozzle(s) moves from the first location to the second location. Moreover, it will be appreciated that although the acceleration presented herein represents an approximately two-fold increase, the acceleration, as well as any deceleration, can be an increase of approximately 1.25 times, an increase of approximately 1.5 times, an increase of approximately 2.5 times, an increase of approximately 3 times, an increase of approximately 5 times, and so forth, with values in between these values also possible. For example, an acceleration from (II) to (III) illustrates an increase of approximately 600 millimeters per minute, which is a value that is an approximate three-fold increase of the original speed, but is only approximately 1.5 times greater than the speed at (II).

Additional curing steps, such as the thermal cure of the multi-stage or dual cure process, can be controlled as well. FIG. 2B illustrates the speed at which the additional cure occurs. As shown from (I)′-(III)′, the speed of the additional cure can remain the same, though it will be appreciated that the speed can change based on, at least in part, the printing and/or the initial curing, the composition of the gel precursor, or the geometry of the part.

Precursor Formulation

An exemplary formulation of the precursor, e.g., the gel passed through the extruder 130 to form the physical gel 200, for extrusion is discussed below. One having ordinary skill in the art will appreciate that the below formulation is merely exemplary, and in some embodiments, one or more of the compounds, sequences of steps, and amounts can be added, removed, or otherwise altered to arrive at a precursor with desired characteristics. Some non-limiting examples of characteristics that can be changed can include polymer properties, loading fractions, solvents, and so forth. Moreover, it will be appreciated that while the above formulation is discussed with respect to CNCs, various forms of nanocomposite gels can be formulated, which can have different compositions and/or characteristics of the precursor.

For fabrication of a CNC-epoxide composite, formulation of the precursor can include adding an epoxide monomer to a solvent to form the colloidal gel. Some non-limiting examples of epoxide monomers can include bisphenol-A-diglycidyl ether, polyethylene glycol diglycidyl ether, among others, which can be used to form a suspension of the monomer therein. The formulation of the precursor can include a single monomer, more than one monomer (e.g., two epoxide monomers), a polymer, and/or one or more oligomers with intermediate molecular weight, these terms being collectively referred to herein at times as a “compound.” In some embodiments, the epoxide monomers of the precursor can include orthogonal cured properties which can be used to simultaneously improve conflicting properties such as strength and ductility. One having ordinary skill in the art will appreciate that polar solvents, such as dimethyl formamide, can form well-dispersed suspensions of colloidal particles with surface charges.

The epoxide monomers can crosslink with the nanomaterial, thereby incorporating suitable functional groups such as hydroxyl groups, to form the nanocomposites. The epoxide monomers can be added to the solvent in various fractions. For example, in some embodiments, the mass of the monomers used in making the precursor can be selected based on a desired nanoparticle to polymer ratio in the cured composite, e.g., the loading fraction. Loading fractions approximately in the range of about 50 percent to about 90 percent, or approximately in the range of about 70 percent to about 90 percent, can produce highly-filled nanocomposites that exhibit strength and toughness characteristic exceeding many engineering polymers, though, it will be appreciated that fabrication of nanocomposites having loading fractions less than 50 percent can also be advantageous in forming certain types of nanocomposites. One having ordinary skill in the art will appreciate that the loading fraction can be expressed in terms of a nanoparticle to polymer ratio, e.g., about 50:50, which can correspond to a loading fraction of approximately 50%, about 70:30, which can correspond to a loading fraction of approximately 70%, or about 90:10, which can correspond to a loading fraction of approximately 90%.

A photoacid generator, such as triarylsulfonium hexafluorophosphate, can be added to the solution to enable UV light initiation of crosslinking. The photoacid generator can be added in various amounts, though, in some embodiments, it can be added such that it is approximately in the range of about 5 percent to about 10 percent of the mass of the epoxide monomers. The photoacid generators can be cationic photoinitiators that, when applied to the CNC composites discussed above, and as appreciated by one skilled in the art, can cause the surface hydroxyl groups of the CNCs to crosslink with the epoxide monomers in a nucleophilic substitution reaction that is adapted for UV curing.

A thermal curing agent can then be added to the solution. The thermal curing agent can be a polyamine, such as 4-aminophenyl sulfone. The thermal curing agent can cause the gel to harden when exposed to elevated temperatures above room temperature during the multi-stage, or dual cure, process. During the thermal curing step of the multi-stage process, the thermal crosslinker can harden the chemical gel 200 to form a hard composite (not shown). More particularly, as applied to the CNC composites discussed above, and as appreciated by one skilled in the art, the polyamine thermal cross linkers can cause the surface hydroxyl groups of the CNCs to crosslink with the epoxide monomers in a nucleophilic substitution reaction that is adapted for thermal curing.

The thermal curing agent can be added in various amounts, though, in some embodiments, one skilled in the art will appreciate that the mass of the thermal agent used can be based on the amount of the epoxide monomer or another of the substances included in the gel. For example, the mass of the thermal curing agent can be chosen such that an epoxy to amine molar ratio is approximately in the range of about 4:1 to about 1:1.

Once the above-mentioned materials are combined, the solution can be stirred until the monomer and the curing agents are well-dispersed. Dispersion of the compounds within the solution can determine the consistency of the extruded gel. Insufficient dispersion can cause the suspension to clump together, which can clog the nozzles of the printer or result in a nanocomposite that lack homogeneity. Homogeneous dispersion of the monomer and the curing agents throughout the solution can allow the solution to achieve a desired consistency throughout when cured. Some non-limiting examples of means for stirring the solution can include a vortex mixer, a blade stirrer, and a turbine stirrer, among others. One having ordinary skill in the art will appreciate that the methods for stirring the solution can vary according to the instruments available, which can be configured to user settings that best achieve the desired consistency.

After the solution is sufficiently homogeneous, a nanomaterial, e.g., CNCs, can be added thereto. The nanomaterial can include an aggregated powder, though, in some embodiments, the nanomaterial can be in chunks, pieces, and so forth. The nanomaterial can be added such that the nanomaterial to solvent ratio is above the gelation threshold for the suspension. One having ordinary skill in the art will appreciate that the gelation threshold is approximately in the range of about 5 percent to about 10 percent by mass, though, in some embodiments, the gelation threshold can be approximately in the range of about 1 percent to about 5 percent by mass, or greater than or approximately equal to 10% by mass. Once added thereto, the nanomaterial can be dispersed throughout the suspension, for instance by using ultrasonic energy, or a mechanical stirring as described above, to break down the nanomaterial into nanoparticles that are dispersed throughout the suspension. A person skilled in the art, in view of the present disclosures, will understand other techniques for dispersing can be used in view of the present disclosures. Further, it will be appreciated that as the sonication energy breaks down the nanoparticles, the suspension is kinetically arrested, forming a homogeneously dispersed colloidal gel.

Additional Printing Processes

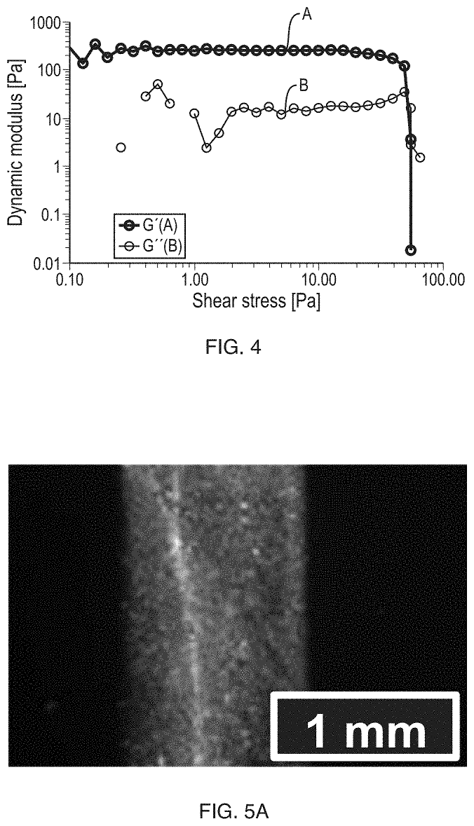

FIG. 3 illustrates the schematics of an embodiment of an exemplary sequence by which the systems, devices, and methods disclosed herein can use the above-described colloidal gel to manufacture a high-performance composite having metal-like properties, such as high stiffness, high toughness, and strength.

In stage (I), the colloidal gel is extruded through the printer 100 to form the physical gel 200. As discussed above, the physical gel 200 is a combination of monomers, thermal and UV crosslinkers, nanoparticles, and solvent. Once extruded, the physical gel can be used for shape forming highly-filled resins. Shape forming can include additive manufacturing, which includes processes such as stereolithography (SLA) and direct ink writing, blade-casting, embossing, and imprinting, among other processes known to those skilled in the art that can utilize the disclosure herein to improve such production processes. In some embodiments, CNC-polymer gels can display the distinctive features of colloidal glasses and the intrinsic chemical additives such as the crosslinkers can be used to tune their behavior during extrusion.

After extruding the physical gel 200 onto the surface 108, the physical gel 200 can undergo an initial cure to partially bond the nanomaterial to the compound, which can change the physical gel into a chemical gel, as shown in stage (II). As shown, the physical gel 200 is deposited onto the surface 108 in layers, with one or more layers being deposited thereon sequentially. The physical gel can undergo the initial cure, which can be a UV cure that irradiates the physical gel 200 using the UV lamp 154, though, in some embodiments, the initial cure can be performed with a halogen lamp, LEDs, or another type of irradiation source. The UV cure can apply one or both of an optical energy or thermal energy to the physical gel 200 to initiate bonding. The optical energy can be applied, for example, using an LED, a projector, a laser, or another energy emitter known in the art. One having ordinary skill in the art will appreciate that the UV cure is applied to each layer of the physical gel 200 to form the chemical gel. In some embodiments, each layer of the physical gel 200 is approximately simultaneously UV cured to form the chemical gel, though it will be appreciated that multiple layers can be UV cured in a single instance. The UV cure can be repeated for a single layer or multiple layers until a part that includes the chemical gel is formed.

The UV cure imparts higher strength onto the polymer network of the physical gel and can evaporate at least some of the solvent contained therein. It will be appreciated that the UV cure can provide mechanical integrity to the extruded layers of the chemical gel, as well as partially crosslink the CNCs and the polymer in the chemical gel. In some embodiments, the chemical gel can be comprised of cellulose nanocrystals and polymer that are partially covalently bonded. The chemical gel also comprises solvent. The chemical gel is considered a viscoelastic solid structure which, as appreciated by one having skill in the art, can allow the chemical gel to be molded into one or more shapes with the application of sufficient force.

Crosslinking the CNCs and the polymer can prevent diffusion of the CNCs as the solvent evaporates throughout the UV cure, which can preserve uniform dispersion of the crosslinked CNCs and polymer in the resulting resin. During the initial cure, as discussed above with respect to FIG. 2, and shown in stage (III) of FIG. 3, the printer can continue to sequentially deposit layers of the chemical gel to print a 3D structure 220 of a desired size and shape. While FIG. 3 illustrates a schematic of such a structure, it will be appreciated that the size and shape of the three-dimensional structure can vary based on preselected user inputs to the printer 100.

After printing, the fabrication process can proceed to stage (IV) in which the 3D structure can be dried to remove the solvent therefrom. The solvent extraction, or drying, can occur at room temperature, or optionally in a partial vacuum, and for a preset time limit. It will be appreciated that the pressure, temperature, and time can be varied based on dimensions, shape, and/or other characteristics of the printed structure. For example, in the case of CNCs, a vacuum setting of about −5 to about −14 psi over a time period of about 12 hours to about 36 hours was found to allow reflow of the partially cured chemical gel, which can remove the solvent and create a densified dried chemical gel 210. Such vacuum settings and time periods, however, are by no means limiting, and can be impacted by a variety of factors, including the desired drying rate and the total volumetric shrinkage anticipated.

The densified chemical gel 210 can undergo a second cure of the dual cure process, which can complete crosslinking of the epoxide monomers. As shown in stages (V)(a) and (V)(b), the second cure can be a thermal cure that can activate the thermal curing agent, e.g., 4-aminophenyl sulfone, that further crosslinks the surface hydroxyl groups of the CNCs with the epoxide monomers. In some embodiments, the thermal cure can include at least two stages during which crosslinking of the epoxide monomers can be completed, which can result in a three-dimensional part of a shape molded part that can be released from the mold. In making the CNC-epoxide nanocomposite resin, the first stage (V)(a) of the thermal cure can be performed at approximately 80 degrees Celsius for approximately 8 hours, and the second stage (V)(b) can be performed at approximately 130 degrees Celsius for approximately 4 hours, though it will be appreciated that the two stages of the thermal cure can occur at varying temperatures and/or pressures, and can be performed over varying amounts of time based on the compounds used in making the nanocomposite. For example, in some embodiments, the temperature of the first stage of the thermal cure can be approximately in the range of about 50 degrees Celsius to about 80 degrees Celsius, or approximately in the range of about 100 degrees Celsius to about 120 degrees Celsius, while the temperature of the second stage of the thermal cure can be approximately in the range from about 120 degrees Celsius to about 180 degrees Celsius, or to temperatures exceeding 180 degrees Celsius. Typically, however, the temperature(s) used for the first cure stage is less than the temperature(s) used for the second cure stage. Likewise, in other instances, more than two stages may be utilized. A single stage can also be used, although some of the benefits highlighted herein may not be as achievable when using a single stage.

In some embodiments, the thermal cure can be performed with an autoclave under elevated atmospheric pressure. The pressure can be up to about 25 psi, up to about 50 psi, up to about 60 psi, or up to about 75 psi, or even greater increase the density of the part and minimize the formation of voids.

The dual cure process offers many advantages for the resulting highly-filled nanocomposite. Traditional additive manufacturing of thermoset polymers is typically accomplished by photopolymerization or paste extrusion followed by thermal curing. When nanoparticles are introduced into the solution, the precursor can become extremely viscous, with flow characteristics more like emulsions and pastes rather than liquids. This can limit nanocomposites to low volume fractions of nanoparticles. One having ordinary skill in the art will appreciate that colloidal gelation typically occurs at relatively low mass fractions (e.g., less than approximately 10 percent), with flow becoming increasingly restricted beyond this threshold. Extrusion can be applied to precursors that are high in viscosity, but extrusion can only be applied when the viscosity is high enough that the extruded bead maintains its shape until curing is accomplished without flowing while still displaying shear thinning or a yield stress necessary for extrusion. One having ordinary skill in the art will appreciate that successful manufacturing methods for highly-filled nanocomposites include formulation of nanocomposite suspensions of polymer, nanoparticles, and solvent, while also having a cure process that is designed to account for solvent loss. Having both a UV cure and a thermal cure for the CNC composite can ensure that the process accounts for volumetric shrinkage while preventing disruption of the microstructure.

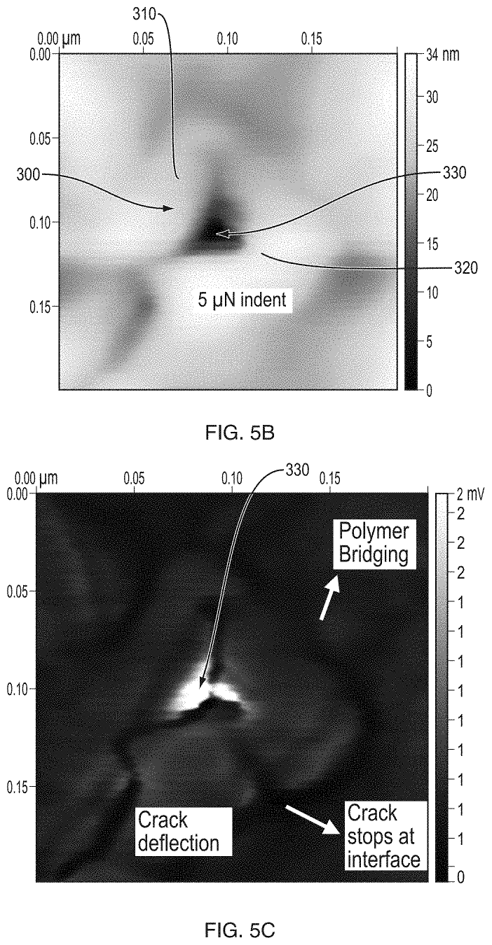

One having ordinary skill in the art will appreciate that additive manufacturing of nanocomposites by direct ink writing can be enabled by a yield stress of the precursor gels. The yield stress of the precursor allows the gel to exhibit a shear thinning behavior that allows it for its extrusion from the syringe 120 for printing. FIG. 4 illustrates yield stress behavior of a typical gel precursor, where (A) represents the storage modulus and (B) represents the loss modulus. The ability of the printer 100 to print depends on the loading fraction of the CNC in the precursor. As shown, when the shear stress is approximately in the range of about 10 Pa to about 100 Pa, the dynamic modulus of (A) is approximately 100 Pa, and the dynamic modulus of (B) is approximately 10 Pa. Further, at shear stresses higher than approximately 75 Pa, the dynamic modulus of (A) falls to approximately 0.01 and the dynamic modulus of (B) falls to 1 Pa. Further, in some embodiments, the pressure of the extruder can adjusted to just above the yield stress of the gel to enable extrusion. Moreover, it will be appreciated that setting the pressure of the extruder to just above the yield stress of the gel can retain the shape of the bead.

The composition of the gel(s) can be determined such that it has favorable shear-thinning characteristics for the type of extrusion system used. For example, in a direct-write printing system, the gel can be designed to regain its storage modulus rapidly after extrusion such that the deposited bead of material retains its shape. In other applications it may be desirable for the gel to lose its mechanical integrity upon extrusion. These characteristics can be determined, for example, at least in part, by the nature of interactions between the CNCs (nanoparticles) and can be tuned, at least in part, via the composition of the gel. Another advantage of the physical gel 200 undergoing the UV cure and a thermal cure separately, is that the resulting CNC nanocomposite has homogeneity of nanoparticles and polymer therethrough to increase hardness and fracture resistance. Substances having large nanoparticle to polymer ratios, e.g., highly-loaded nanocomposites, can experience large volumetric shrinkage associated with solvent evaporation and crosslinking of the nanoparticles and the polymer matrix. Volumetric shrinkage can result in phase separation due to internal flows when the solvent evaporates, which may prohibit use of the nanocomposite for shape forming and additive manufacturing due to internal flows when the solvent evaporates that contribute to a frequently-changing shape of the nanocomposite.

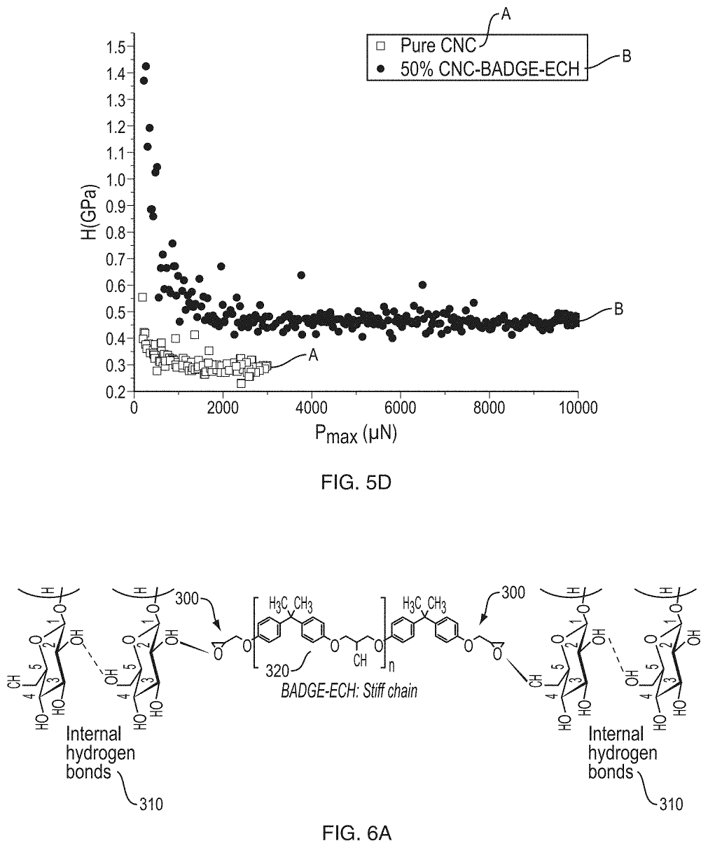

The dual cure process allows the organization of the CNC microstructure generated by extrusion of the highly-filled nanocomposite to be retained during removal of the solvent and curing. As shown in FIG. 5A, the ordering of CNCs is not lost by diffusion or internal flows. That is, long-range alignment and orientation of the cellulose can be controlled and retained as a result of the dual cure process, allowing the cellulose to maintain alignment during printing.

Control over the granular aspects of the compounds that make up the CNC composite can allow customization of the composite and the interaction at the CNC-polymer interface of the composite. Further, AFM imaging and indentation can be used to observe behavior on a molecular level at the CNC-polymer interface of the composite. For example, FIGS. 5B and 5C illustrate a fracture mechanism at the interface 300 of the CNC 310 and the polymer 320 in a CNC composite detected using an AFM scan after an indent 330 was formed therein. It will be appreciated that the response to the indent is representative of plastic deformation of the composite resulting from other forms of loading.

As shown in FIG. 5B, the indent 330 can be located in the approximate middle of a grain region of CNCs bonded mainly by van der Waals interactions 310 and polymer 320, and is thus relatively weaker and more brittle. This can be surrounded by a wider amorphous polymer region, which can contain chemically crosslinked CNCs, and is thus strongly bonded. It will be appreciated by one skilled in the art that the indent 330 is localized within the brittle region and does not propagate to the strongly crosslinked region. FIG. 5C further illustrates radial cracks 340 that extend from the indent 330. As shown, the radial cracks 340 that originate at the indent can be deflected and can terminate at the grain boundary.

The resulting highly-filled CNC composite films shows a significant improvement in mechanical properties versus pure CNC films. In addition to having a higher resistance to crack propagation, other properties of the CNC composites can be superior to pure CNC films by optimizing the formulation, cure process variables, and polymer properties of the CNC composite according to the methods discussed above. For example, in some embodiments, the CNC composites can include a hardness that is approximately 2 times to approximately 3 times that of pure CNC films. FIG. 4D illustrates a comparison of hardness versus applied force of pure CNC films (A) and a CNC-epoxide film having a loading fraction of approximately 50 percent (B) that is made by the processes discussed above. The applied force can be measured by nanondentation with a Berkovich tip or by another instrument known to one skilled in the art. As shown, values of the CNC composites can be as high as approximately 1.5 GPa at low applied forces, and can maintain a hardness of approximately 0.5 GPa at forces of up to approximately 10,000 μN, as compared to approximately 0.55 GPa at low applied forces and approximately 0.25 GPa at forces of approximately 3,000 μN for pure CNCs.

In some embodiments, different interfacial properties can be obtained by varying the stiffness of the polymer interface to further engineer nanocomposite properties, such as rigidity, strength, and/or flexibility. For example, using monomers having different chain properties in the formulation of the physical gel can alter the structure of the resulting nanocomposite.

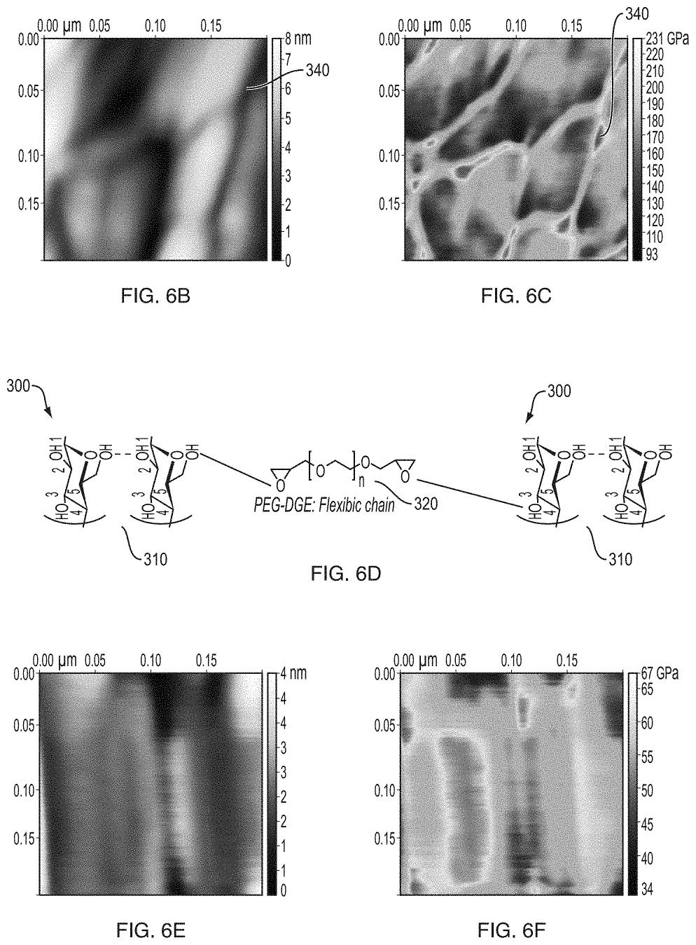

FIGS. 6A-6C illustrate an exemplary molecular structure of a CNC-polymer interface 300 that includes a Bisphenol-A-diglycidyl ether based monomer with a stiff aromatic chain. As shown, an alternating sequence of CNCs 310 and polymer 320 can propagate throughout the molecular structure of the composite such that the polymer interface can be defined between the CNCs 310 and the polymer 320. The interfacial structure of the CNC-polymer interface 300 includes the individual CNCs having internal hydrogen bonds and covalent bonds formed between the CNC and the epoxide ring of the aromatic chain. It will be appreciated that, in some embodiments, the inclusion of crystalline nanoparticles can increase the heat deflection temperature of the polymer in the composite, which can be used for tooling the thermoforming and/or short-run injection molding inserts.

FIGS. 6B and 6C illustrate the resulting topology of the non-limiting, exemplary CNC composite. As shown, the grains of the CNC composite are significantly reinforced from their nominal transverse modulus of approximately 50 GPa, which is characteristic of pure CNC films. Furthermore, the crosslinked grain boundaries 340 can have a high stiffness, as visible according to their strained configuration.

In contrast, FIG. 6D illustrates an exemplary molecular structure of a CNC-polymer interface that includes a flexible polymer. For example, as shown in FIG. 6D, a polyethylene glycol diglycidyl ether chain can be used in lieu of, or in addition to, the stiff aromatic chain in the composite. The higher flexibility in the CNC-polymer interface is reflected in the topography and modulus analysis illustrated in FIGS. 6E and 6F. As shown, the CNC-polymer interface can have significantly lower stiffness as compared to the stiffness of the grains. The grain boundaries can be less visible between the grains of the CNC composite as the added flexibility allows the grains to more closely abut one another. Further, there can be higher energy dissipation at the CNC-polymer interface, with lower stiffness in the composite.

In some embodiments, properties of the composite can be tuned by varying the bonds between molecules in the polymer chain, alternating monomers of high and low stiffness, brittleness within a single chain, and/or incorporating two separate polymer networks with different properties for different nanoscale load transfer and failure mechanisms.

It will be appreciated that any tuning be performed using the same formulation methods and cure processes, which can ensure scalability and compatibility with direct-write additive manufacturing as discussed above. As a result, nanomechanical properties can be directly integrated into bulk nanocomposite parts by fabricating bulk nanocomposites with nanoscale features.

Exemplary Printed Components

In some embodiments, the highly-filled nanocomposites provided for herein or otherwise derivable from the present disclosures, can be incorporated or used in lieu of, or in addition to, various structures to manufacture objects having enhanced mechanical properties. For example, the highly-filled nanocomposites can exhibit metal-like properties that enable them to be used for fabrication of parts and/or structures that use high toughness materials, such as bicycles and drones. Although discussed in the present disclosure with respect to manufacture of objects that exhibit toughness and fracture resistance, a person skilled in the art will recognize that these are by no means limiting of the types of objects and/or the type of environments with which the present disclosures can be utilized. By way of non-limiting examples, the highly-filled nanocomposites can be using in conjunction with: medical and dental products, such as dentures, implants, and surgical instruments that can utilize the strong mechanical properties and the biocompatibility enabled by cellulose to introduce these nanocomposites into a patient; everyday electronics, such as cellular telephones and computers; a solar panel or cell, which endures varying outdoor conditions, and so forth. In some embodiments, the highly-filled nanocomposites provided herein can be used in the shape molding and/or the additive manufacturing of razor blades having nanoscale edge thickness, additional details of which can be found in U.S. Provisional Patent Application Ser. No. 62/780,141, entitled “Cutting-Edge Structures and Method of Manufacturing Cutting-Edge Structures” (Docket No. 15429P), which was filed on the same date as the provisional application from which the present application claims priority (Dec. 14, 2018), and U.S. patent application Ser. Nos. 16/771,520, 16/771,524, and 16/711,539, each entitled “Cutting-Edge Structures and Method of Manufacturing Cutting-Edge Structures” (Docket Nos. 15429, 15429M, and 15429M2, respectively), which were each filed on the same date as the present application (Dec. 12, 2019), the contents of all four applications being incorporated by reference herein in their entireties.

The present disclosures can be applied to any object involving fabric. A person skilled in the art could easily apply the present disclosures to manufacturing apparel, various medical implants that include fabric, and in general most any object in which a fabric is used. Generally, the present disclosures are advantageous for any fabric because traditional fabrics that are woven or knitted have the same density across a surface area because otherwise it would typically unravel, while the present disclosures allows material to be deposited only where it is needed, so there is not necessarily a uniform density. Still further, these techniques can also be applied outside of objects having fabric, and can be more broadly applied to any 3D printing technique. In fact, any object involving gels or films can be printed using the systems, devices, and methods provided for herein. A person skilled in the art could easily apply the present disclosures to almost any object in which a gel is used. Still further, these techniques can also be applied outside of objects having gel, and can be more broadly applied to any 3D printing technique. Additionally, a person skilled in the art will recognize that the fabrication techniques provided for in the present disclosure can be adapted to other forms of fabrication beyond additive manufacturing, including but not limited to extrusion, stereolithography (SLA), direct ink writing, casting (e.g., blade-casting), embossing, and imprinting.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A method for preparing a precursor, comprising:
adding a compound to a solvent to form a solution;
mixing the solution until the compound is dispersed throughout the solution;
adding one or more curing agents to the solution, the one or more curing agents being configured to permit crosslinking between a nanomaterial and the compound;
adding the nanomaterial to the solution such that a physical gel is formed; and
dispersing the nanomaterial such that the physical gel is homogeneous.

2. The method of claim 1, further comprising bonding the nanomaterial to the compound to create a chemical gel.

3. The method of claim 2, wherein the bonding is initiated by applying at least one of an optical energy or a thermal energy.

4. The method of claim 2, further comprising shape forming the chemical gel into a nanocomposite of a desired shape.

5. The method of claim 4, wherein shape forming further comprises one or more of additive manufacturing, extrusion, stereolithography, casting, embossing, and imprinting.

6. The method of claim 4, further comprising:
performing a first thermal cure over a first period of time at one of a first temperature and a first temperature range; and
performing a second thermal cure over a second period of time at one of a second temperature and a second temperature range,
wherein the first temperature is less than the second temperature and temperatures used in the first temperature range are less than temperatures used in the second temperature range.

7. The method of claim 6, wherein the first temperature range is approximately in the range of about 50 degrees Celsius to about 100 degrees Celsius, and the second temperature range is approximately in the range of about 120 degrees Celsius to about 180 degrees Celsius.

8. The method of claim 4, wherein the nanomaterial to compound ratio in the nanocomposite can be approximately in the range of about 50:50 to about 90:10.

9. The method of claim 4, further comprising adding a second compound having different chain properties to the precursor to change the stiffness of the nanocomposite.

10. The method of claim 1, wherein an amount of nanomaterial that is added to the solution is an amount such that the nanoparticle to solvent ratio is at or above approximately 5 percent by mass above a gelation threshold for suspension.

11. The method of claim 1, further comprising adding one or more of a photoacid generator and a thermal curing agent to the solution.

12. The method of claim 1, further comprising at least one of:
exposing the combination of the nanomaterial, the solution, and the one or more curing agents to one or more wavelengths of light, or
heating the combination of the nanomaterial, the solution, and the one or more curing agents to a temperature that exceeds approximately room temperature,
to cause crosslinking between the nanomaterial and the compound to occur.

13. The method of claim 1, wherein the nanomaterial comprises at least one of a nanocrystal, a nanotube, or a nanoplatelet.

14. The method of claim 13, wherein the nanomaterial comprises a cellulose nanocrystal.

15. A method of printing a three-dimensional part, comprising:
preparing a precursor, the precursor comprising a compound, nanostructures, a solvent, and one or more curing agents;
loading the precursor into a printer;
depositing the precursor from the printer onto at least one of a surface or one or more layers of previously deposited precursor;
exposing the precursor to at least one of optical energy or thermal energy such that the nanostructures become partially bonded to the compound via activation of at least one curing agent of the one or more curing agents;
extracting the solvent from the deposited materials;
repeating the depositing, exposing, and extracting actions to form a three-dimensional part, and
exposing the three-dimensional part to at least one of optical energy or thermal energy to further increase the number of crosslinks between the nanostructures and compound via activation of at least one curing agent of the one or more curing agents.

16. The method of claim 15, wherein depositing the precursor further comprises one or more of extrusion, blade-casting, direct ink writing, embossing, and imprinting.

17. The method of claim 15, further comprising extruding the precursor at a preset pressure that is higher than a yield stress of the precursor.

18. The method of claim 15, further comprising varying a ratio of the nanoparticle to compound in the precursor to change a composition of the precursor.

19. The method of claim 15, further comprising varying a speed of deposition of the precursor and a speed of curing of the precursor.

20. The method of claim 15, wherein the actions of depositing the precursor and curing the deposited precursor occur approximately simultaneously.

21. The method of claim 15, wherein a ratio of the nanoparticle to the compound in the nanocomposite is approximately in the range of about 50 percent to about 90 percent.
